(19) United States
(12) Patent Application Publication
(10) Pub. No.: US 2025/0351986 A1
(43) Pub. Date: Nov. 20, 2025

(54) PACKAGE RECEPTION AND STORAGE DEVICE AND PACKAGE RECEPTION AND DELIVERY SYSTEM

(71) Applicant: Masami TAKEDA, Mishima-shi (JP)

(72) Inventor: Masami TAKEDA, Mishima-shi (JP)

(21) Appl. No.: 18/854,842

(22) PCT Filed: Apr. 6, 2023
(86) PCT No.: PCT/JP2023/014942

§ 371 Date: Oct. 7, 2024

(30) Foreign Application Priority Data
Apr. 8, 2022 (JP) 2022-071942

(51) Int. Cl. A47G 29/14

(52) U.S. Cl. CPC A47G 29/141; A47G 2029/146; A47G 2029/149

(57) ABSTRACT

A foldable storage warehouse at a package reception door and the back thereof inside the entrance door, allowing a deliverer to unlock a package reception door by means of a variable dial lock or electronic lock, allowing a deliverer to unfold, through an extruding or drawing operation, the storage warehouse, in the front and rear of the door, that can secure almost the same height and front width as the size of the door and a depth equal to or greater than the front width of the door, and store the package. In addition, delivery, reception, and collection with more improved crime prevention and workability can be implemented by using an electronic lock system using a smartphone and a dedicated application.

### TECHNICAL FIELD

The present invention relates to a package storage device and a locking and unlocking system using a door.

### BACKGROUND TECHNOLOGY

In recent years, the number of product purchases through mail order such as television and the Internet has increased, and due to the influence of recent infectious diseases, the number of product purchases through mail order delivery companies is increasing, such as a decrease in face-to-face shopping and a decrease in opportunities to go out due to an increase in working from home.

As a result, while the business operation rate of delivery companies is increasing, the problem of redelivery, where the delivery person takes the package back and then delivers it again when the orderer is not present, is also increasing, increasing the burden on delivery companies, and a new problem has arisen in which people do not want to increase the number of face-to-face opportunities due to infection control measures, and solutions to these problems are required.

As a solution to such problems, delivery boxes have been devised in the past, and proposals have been made ranging from a method of having a signature stamp built into the delivery box to one equipped with an automatic stamp function and a voice input function. (Reference 1)

In addition, it is difficult to secure space to install a large delivery box around the entrance of a normal house, and although a large box can be installed if there is a gate, it is time-consuming to carry packages from the gate to the entrance, which is inconvenient on rainy days. Therefore, as a way to install a box that does not get in the way around the entrance, a method has been proposed in which the box is folded up and attached to the entrance door when not in use, and then assembled and left waiting on the scheduled day of receipt. (Reference 2)

In addition, in the past, delivery service users would go out with the delivery box's receiving door unlocked, have the delivery person open the receiving door and store the package, and then have the delivery person lock it or automatically lock it, and the recipient would unlock it with their own key or the like to receive the package. This made it difficult to prevent mischief by a third party, such as inserting foreign objects, while the box was unlocked and waiting, and it was not possible to receive packages multiple times a day.

Regarding the above-mentioned problems of pranks and multiple deliveries, with the recent widespread use of so-called smartphones (hereafter referred to as “smartphones”), technology has been proposed to remotely unlock and lock the receiving door of a delivery box. (Reference 3)

In this proposal, a note instructing the user to call the delivery person to unlock the box is attached to the delivery box, and the delivery service user receives a call from the delivery person when the delivery person arrives at the site and remotely unlocks the box. Some products have a camera installed in the box as a security measure, allowing the user to receive packages while monitoring the operation.

This type of product is based on the premise that the delivery service user has an environment where they can connect to the Internet at home, and when they have built a home network system that can be used for surveillance cameras using their smartphones, the delivery box is incorporated as one terminal in the system and used. The router and a repeater for the home network system are connected by a wireless LAN such as Wi-Fi (registered trademark), and this repeater is further connected to the communication terminal stage of delivery boxes up to 70 meters away via DECT (Digital Enhanced Cordless Telecommunications) communication, allowing remote operation of locking and unlocking and remote monitoring of package receipt.

### PRIOR ART DOCUMENTS

### Patent Documents

[Patent document 1] JP Patent Publication No. 06-345185
[Patent document 2] JP Patent Publication No. 08-182604
[Patent document 3] Utility model registration No. 3235404

### SUMMARY OF THE INVENTION

### Problem that the Invention Aims to Solve

However, even with the above-mentioned improvement proposals and improved products, the following problems still remain.
A. There is little installation space around the entrance, making it difficult to receive large packages.
   Even if the box is foldable, it requires work space for assembly, disassembly, and folding, and it also increases the workload, making it difficult to make it heavier. Due to the loading configuration, there are restrictions on the weight and height of the package that can be used, making it particularly difficult to store long items such as skis, golf bags, and fishing rods.
B. Increased cost due to larger box size and installation work Even if there is enough space around the entrance, costs will increase as the size and components of the delivery box increase, and installation work including foundation work will be required to safely hold large containers, increasing costs. do.
C. It is difficult to take measures to prevent unauthorized opening by someone other than the delivery person.
   With the above-mentioned mechanical lock system, the delivery box must be left unlocked and on standby on the scheduled delivery date, and it remains difficult to prevent mischief during this time.
D. You can only receive it once a day.
   With mechanical locks, once you receive your package, it will be locked and you will not be able to receive your next package.
E. Even if the electronic lock can be locked and unlocked multiple times by remote control, it still requires the delivery company to respond each time.
   If a wireless locking and unlocking means and a camera were added to the delivery box and remote control was possible with a smartphone, it would be possible to prevent vandalism and allow multiple package to be received, but since the delivery person would need to be responded to while the person is out, it would be impossible to receive package while at work, and the original convenience of the delivery box, which is to be able to receive package without meeting the person in person while the person is not at home, would be lost.
F. Even if you can receive the item multiple times, the delivery of the package delivered after it is full will be wasted.
   If it becomes possible to receive items multiple times by remote control, the delivery person will not notice if the delivery box becomes full during repeated deliveries, and redelivery will be necessary.
G. When shipping a package, you need to go to the delivery person or hand it over face-to-face at home.
   Conversely, if you want to ship a package, the delivery service user should either “bring the package to the delivery person or a convenience store affiliated with the delivery person,” or “contact the delivery person and wait until they come to your home to pick it up.” In addition to having to pay for one of these, there is no choice but to hand over the package face-to-face. Issues such as these remained.

The present invention improves each of the above-mentioned problems and makes effective use of the space around the entrance, “at least when there is no package reception, it does not occupy unnecessary space”, and “the size is close to the entrance door and the depth is close to the width of the frontage.” “It is possible to create a large storage compartment with a door by simply replacing or installing the door.” “There is no need for assembly or disassembly, and the storage compartment can be opened by simply pushing out or pulling out.” “Even mechanical locks prevent tampering while waiting to receive packages.” “Even with an electronic lock, it is possible to receive package multiple times without face-to-face contact while you are away.” In addition to solving the conventional problems of “preventing the waste of having to re-deliver to the delivery person” and “on the contrary, if you want to ship the package from home, it is possible to ship the package without meeting face-to-face,” it will also enable the development of new forms of service usage. An object of the present invention is to provide a package receiving and storing device and a package receiving system.

### Means to Solve the Problem

In order to solve each of the above-mentioned problems, the present invention provides an entry/exit door with a package receiving door, and a folding storage means that can expand the storage by pushing out or pulling out the door at the back of the package receiving door. At times, while the entry/exit door is kept locked, the delivery person unlocks the package receiving door and stores the package in the storage box formed by unfolding the storage means.

Further, according to the present invention, the package receiving door has a package receiving doorknob, a package receiving locking/unlocking means, and a package receiving hinge, and the storage compartment has a height and a width of the door. It is characterized by having a height and width excluding the locking/unlocking part of the entry/exit door and the door frame part, and being able to form a depth greater than the width.

Further, according to the present invention, the surface door of the entry/exit door also functions as the package receiving door.

A separate type door knob that is used as a doorknob and separates into an inner and outer part when the outer knob is pulled while the inner knob is in a fixed state, and an entrance/exit restriction plate having the storage means is provided on the back of the surface door, and the entrance/exit restriction plate is provided at the back of the surface door. unlocking both the locking/unlocking means for the door and the surface door to integrate the outer knob and the inner knob to enter and exit, and when receiving the package, lock the entrance/exit restriction plate and unlock the surface door to separate. The present invention is characterized in that the surface door with the outer knob is opened and the exposed folding storage means is unfolded to store the package.

Further, according to the present invention, an entry/exit with storage means for retrofitting is provided on the indoor side of the existing door.

A regulation plate is provided, and the entry/exit regulation plate for retrofitting is installed.
A building-side fixing member for fixing to the left and right door frames on the building side;
an existing door side fixing member for fixing to the existing door side;
are provided respectively, and a fixing destination joint switching means is provided inside the entrance/exit regulating plate,
   Variable dial that has the function of transferring rotational force from existing doorknob to latch bolt.
   Replace the doorknob with a separate doorknob with a lock.
a rotatable claw member is brought into contact with the surface of the entrance/exit restriction plate facing the existing door, sandwiching the knob portion of the existing thumb turn;
   The present invention is characterized in that a second thumb turn is provided which has a function of extending and rotating the pawl member from the indoor surface side of the entrance/exit restriction plate and a function of switching a connection to which the entrance/exit restriction plate is fixed.

Further, according to the present invention, in each of the above devices, an indoor side opening/closing means that can be opened and closed only from the indoor side is provided on the back side wall plate of the storage wall after the folding storage means of the package receiving door is expanded. It is characterized by

Further, according to the present invention, the package receiving door includes a package receiving door having a built-in drawer-folding storage means on the outside of the existing door, by gluing, screwing, belt fixing, or attaching the package receiving door to the existing doorknob. A package receiving and storing device characterized by being connected and fixed or a combination of these and fixed afterwards.

Further, according to the present invention, as the means for unlocking the package receiving door by the delivery person, the tracking number issued at the time of order or the number of predetermined digits from the predetermined digit position to the predetermined digit direction of the telephone number of the delivery service user is used. is set in the variable mechanical lock as an unlock code, and then locked, the tracking number given to the package label by the delivery person or the specified digits from the specified digit position to the specified digit direction of the delivery service user's telephone number. An instruction section is provided that instructs the delivery person to input a number as a PIN number, and the delivery person unlocks the code-input mechanical lock according to the instructions of the instruction section, stows the package, and then closes the door. It is characterized by automatic locking.

Furthermore, according to the present invention, in each of the above devices, a wireless locking/unlocking means having a power supply unit, a communication unit, a control unit, a memory unit, and an actuator drive unit is provided, and an application dedicated to operating the wireless locking/unlocking means is distributed on the Internet, and both the delivery service user and the delivery person register the dedicated application using a communication terminal with a long-distance communication means, and when the delivery person arrives at the delivery destination, either types in the necessary information via the application or reads the code information attached to the package with the communication terminal, the application automatically transmits the package receiving door unlock request signal via the long-distance communication means to the communication terminal of the delivery service user, and the delivery service user who receives the signal transmits an unlock signal via the application, or the application automatically compares the package information, location information, and order information of the delivery service user, and automatically transmits the unlock signal when the necessary information matches.

After transmitting an unlocking signal to the delivery person's communication terminal via the long-distance communication means, the dedicated application unlocks the package receiving door using the short-range communication means of the delivery person's communication terminal. After transmitting an unlock code to the carrier and unlocking the package receiving door, delete the unlock signal data from the communication terminal of the delivery person.

Or, Alternatively, a long-distance communication means is added to the communication section of the wireless locking/unlocking means, and the application transmits the time-limited unlocking code that is decoded using pseudo-random numbers or the like via the long-distance communication means to the wireless locking/unlocking means. and the communication terminal of the package delivery person, and the wireless locking/unlocking unit unlocks the package receiving door only when both unlock codes match within a time limit.

After storing the package using any of the above methods, when the package receiving door is closed, the door is automatically locked, and at the same time, a receipt completion notification is sent to the delivery service user via the application.

Further, according to the present invention, in each of the devices, lighting means is provided above the storage means;

An imaging means or an imaging means and a distance measuring sensor are provided, and image information at the time of package storage by the delivery person is distributed to the delivery service user via the application, and the image is stored on the communication terminal or cloud server. At the same time, the delivery person can sequentially obtain image information of the destination storage through the application when preparing to deliver the package, and based on the image information,

The delivery person itself is made aware of the space occupied by the existing packages in the storage warehouse, and then.

Whether the package scheduled to be delivered twice is large enough to accommodate additional storage, or

Or, based on the image information or image information and distance measurement information, the calculation function of the dedicated application

Or, using the computing device of the application development manager, notify the space occupied by the existing package in the storage and the size of the package that can be additionally stored;

The present invention is characterized in that information for determining whether new packages can be additionally stored before delivery can be provided to the delivery person via the dedicated application using any of the above methods.

According to the present invention, in each of the above devices, after the delivery service user stores the package that the delivery service user wants to send in the storage unit,

When the delivery service user locks the package with a mechanical lock such as a variable dial lock or a numeric keypad lock, the delivery service user communicates the unlocking code of the mechanical lock to the delivery company by telephone or e-mail, etc., and the door is unlocked.

When the delivery service user uses the wireless locking and unlocking means, after registering a package pickup request with the delivery company in advance via the dedicated application, the delivery person that has arrived at the pickup destination transmits the package receiving door unlocking request signal, which includes the delivery information and current location information, and the dedicated application automatically transmits the unlocking code to the communication means of the delivery person, and the dedicated application transmits the unlocking code to the wireless locking and unlocking means via the short-distance communication means of the communication means of the delivery person to unlock the door.

The device is characterized in that it enables the delivery of packages sent to a home by one of the above methods.

### Effect of the Invention

By using the present invention, it is possible to promote the effective use of the space around the entrance as a means for receiving and storing delivered packages, and without having to sacrifice wasted space at least when there is no package reception, A large storage compartment with a height, width, and depth similar to the width can be realized by simply replacing or installing a door, and the storage compartment can be expanded by simply pushing out or pulling out, without the need for complex assembly work.

This makes it possible to “prevent unnecessary re-delivery by delivery person” and makes it possible to “receive package multiple times without face-to-face contact while the delivery service user are absent” and “even with a mechanical lock, it will not be pranked with while waiting to receive the delivery service user's package”. In addition to solving problems with conventional delivery boxes, it will also be possible to use new services, such as “conversely, even when shipping packages from the delivery service user's home, this user can have the delivery person pick up the package without face-to-face contact while you are away”.

### BRIEF EXPLANATION OF DRAWINGS

FIG. 1 is a diagram showing the configuration and usage method of a package receiving and storing device according to a first embodiment of the present invention, and FIG. 1(A) is a perspective view of a state in which a locked access door is about to be opened; FIG. 1(B) is a perspective view after opening the entrance/exit door, FIG. 1(C) is a perspective view of the delivery person trying to open the package receiving door with the entrance/exit door closed, D) is a block diagram of the remote locking/unlocking device, FIG. 1(E) is a perspective view after opening the package receiving door, FIG. 1(F) is a perspective view of the folding storage means pushed out and unfolded. FIG. 1(G) is a top view of the locking/unlocking means in a horizontal cross-sectional position with the package receiving door closed, and FIG. 1(H) is a top view of the locking/unlocking means in a horizontal cross-sectional position with the package receiving door open. It is a diagram.

FIG. 2 shows the various components and environment required when a delivery person that has arrived at a delivery destination unlocks the package receiving and storing device according to the first embodiment of the present invention using a network-connected communication terminal. It is a diagram.

FIG. 3 is a diagram showing the state of the storage at the delivery destination before the delivery, when a delivery person intends to deliver the cargo to the delivery destination using a communication terminal connected to the package receiving and storage device in the first embodiment of the present invention via a network.

FIG. 4 is a diagram illustrating the configuration and usage method of a package receiving and storing device according to a second embodiment of the present invention. FIG. 4(A) is an oblique view of the pull-out type package receiving door just before it is pulled out towards the front, FIG. 4(B) is an explanatory diagram of the direction in which the doorknob is turned to remove the package receiving door from the entrance/exit door, FIG. 4(C) is an explanatory diagram of the rear view and unfolding direction when a top plate and a bottom plate are added to the folding storage means, FIG. 4(D) is an oblique view of the package receiving door when it is pulled out, and FIGS. 4(E) and 4(F) are oblique views of when a bellows-shaped cover and a bag-shaped cover are added to improve the waterproofness of the package receiving door after it is unfolded to the outside.

FIG. 5 is a diagram showing the configuration and usage method of a package receiving and storing device according to a third embodiment of the present invention, and FIG. 5(A) shows a drawer type package receiving door unit installed on the surface of an existing entrance/exit door. FIG. 5(B) is a perspective view of a state in which a drawer-type package receiving door unit is retrofitted and fixed to the surface of an existing entrance/exit door.

FIG. 6 is a diagram showing the configuration and usage method of a package receiving and storing device according to a fourth embodiment of the present invention, FIG. 6A is a perspective view of a state in which a delivery service user is about to open the entrance/exit door and baggage receiving door for entering/exiting. and FIG. 6(B) is a top view in horizontal section of the locking/unlocking means with the door closed, and FIG. 6(C) is the locking/unlocking means with the door open. FIG. 2 is a top view at a horizontal cross-sectional position. FIG. 6(D) is a perspective view of the delivery person trying to open the access door and package receiving door for storing the package, and FIG. 6(E) is a horizontal view of the locking/unlocking means with the package receiving door open. The top view in the cross-sectional position and FIG. 6(F) is a perspective view with the package receiving door opened to expose the folding storage means.

FIG. 7 is a diagram showing the configuration and usage method of a package receiving and storing device according to a fourth embodiment of the present invention, and FIG. 7(A) is a diagram showing the outer knob of the existing door knob for entry/exit to be replaced with a variable combination lock. FIG. 7(B) is a perspective view of the state immediately before opening, and FIG. 7(B) is a perspective view of the existing door being opened and retrofitted parts added to the left and right door frames on the building side and the back of the existing door. FIG. 7(C) is the retrofitted parts. FIG. 7(D) is a perspective view of the access door opened after the addition and after the folding storage means has been pushed out and unfolded, and FIG. 7(E) is a perspective view of the door opened. FIG. 7(F) is a top sectional view of the vicinity of the doorknob, and is an explanatory diagram of the three-state switching position of the second thumb turn.

### FORM FOR CARRYING OUT THE INVENTION

Hereinafter, embodiments of a package receiving and storing device and a package receiving system according to the present invention will be described in detail based on the drawings. Note that the package receiving and storing device and the package receiving system according to the present invention are not limited to this embodiment.

### First Embodiment

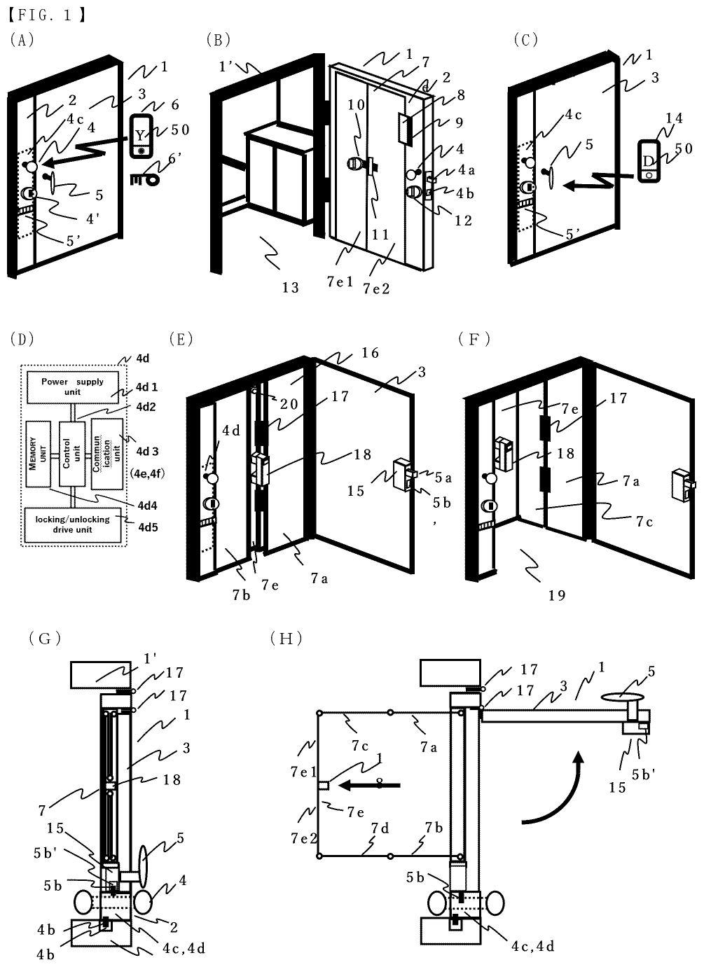

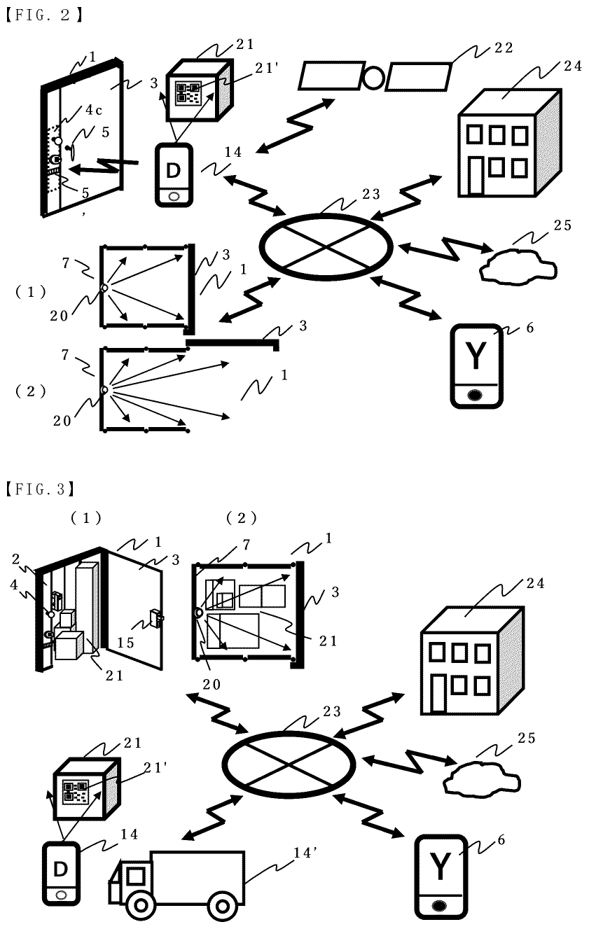

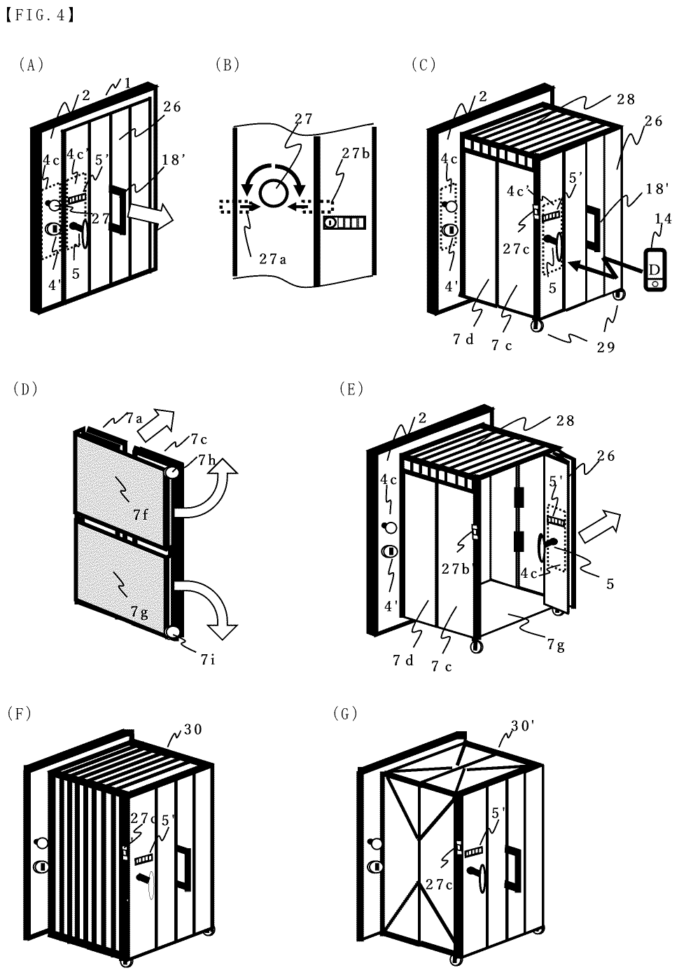

FIG. 1 is a diagram showing an overview of the package receiving and storing device according to the first embodiment of the present invention according to the six different usage conditions and observation directions shown in FIG. 1(A) to (F). The detailed explanation will be given below along with each of the figures in FIG. 1(A) to 1(F).

### <Opening/Closing the Entrance/Exit Door>

FIG. 1(A) is a perspective view of the package receiving and storing device of the present invention, which is a door with a package receiving and storing compartment, in a closed state. In addition to unlocking the door by turning the doorknob 4 and pulling it, you can also use the delivery service user's communication terminal (hereinafter referred to as the smartphone 6 to open the locking/unlocking device 4c (built-in within the dashed line frame in this drawing). Bluetooth (registered trademark) is used as a communication means for the remote locking/unlocking device 4d, which is comprised of a power supply unit 4d1, a control unit 4d2, a communication unit 4d3, a data storage unit 4d4, a locking/unlocking drive unit 4d5, etc. in FIG. 1(D). Using a wireless PAM-based short-distance communication means 4e such as First, an entry/exit door unlocking code is transmitted, received by the communication unit 4d3, and the unlocking code signal is registered in the storage unit 4d4 via the control unit 4d2.

After that, when unlocking, use the dedicated application 50 to send the door unlock code signal. When you press the unlock button displayed on the screen of the smartphone 6 near the door 1, the unlock signal is sent from the smartphone 6 to the communication section. The control unit compares the code with the registered unlock code in the storage unit, then activates the lock/unlock drive unit and drives actuators such as motors and solenoids to return the deadbolt position inside the door to the unlocked position. At the same time as the door is unlocked, a completion signal is received from the door side, and “unlocking complete” is displayed on the display screen of the dedicated application 50 of the smartphone 6.

On the other hand, when locking with an electronic lock, a registered entrance/exit door locking code signal is similarly transmitted near the locked entrance/exit door 1, or an automatic locking mechanism (mechanical or electronic) is used to lock the door. Then, at the same time as the lock is locked, a lock confirmation signal is transmitted to the smartphone 6 in the same manner as when unlocking, so that the lock can be confirmed.

FIG. 1(B) shows the unlocked entrance door 1 opened to expose the entrance inner space 13. On the back of the entrance door 1 opened from the building door frame 1′, there are a doorknob 4 and a thumb turn 12 on the indoor side of the entrance door locking/unlocking unit frame 2, an entrance door notch bolt 4a and a dead bolt 4b on the side, a rear partition plate 7e of the folding storage means 7 in the center of the inner surface, a magnetic metal plate 8 on its side end, and a magnetic plate 9 on the inner surface of the entrance door locking/unlocking unit frame 2 on the opposing surface (here, a simple configuration using magnetic force is used to magnetically attach the rear partition plate 7e to the indoor side of the entrance door locking/unlocking unit frame 2, making it easier to work when unfolding and storing, but it goes without saying that it may be provided on the left and right sides or at the four corners for greater stability, and other mechanical weak fixing holding mechanisms other than magnetic force may be used). Furthermore, a lock lever 10 and a hook 11 are provided in the center of the rear partition plate 7e to enable opening and closing to the left and right 7e1 and 7e2. (Note: In this configuration, a strong hinge is used because the dedicated door is intended to replace the existing door, but casters can be provided at the bottom of the partition to distribute the load to the floor and reduce the burden on the existing door hinge.)

### <Opening and Closing the Package Receiving Door>

First, when the delivery service user himself locks and unlocks the package receiving door 3, he can use any of the following: a physical key, a variable combination lock, or wireless communication.

In order to achieve the objective of the present invention, which is to have the delivery person open the package receiving door built into the door and then unfold the folding storage means inside to store the package, there are two ways to have the delivery person open the package receiving door 3: using a mechanical lock such as a dial or numeric keypad, or using an electronic lock. The procedure for the delivery person to open the package receiving door 3 when it arrives at the delivery destination from the state in which the entrance door 1 in FIG. 1(C) is closed and locked will be explained below.
A: When using a mechanical lock whose PIN number can be rewritten at any time.
   A four-digit variable combination lock 5′ with a physical keyhole on the left end as a mechanical lock that allows the PIN to be rewritten at any time (the number of digits is not limited to four, and the number of digits can be increased by using a numeric keypad-type mechanical lock to improve security). There are two methods for requiring the user to input the unlocking PIN code in advance.
a. If there is only one package scheduled to be delivered on the same day
   Among the “product tracking numbers (inquiry slip numbers)” created by the mail order person when ordering a product, notified in advance to the delivery service user, and written on the label of the delivery package,
   “How many digits above or below the code from the number digit”
   The machine lock is registered and locked in advance, and instructions for inputting this code are displayed around the mechanical lock so that the delivery person can unlock it based on the label of the package.
b. If there are multiple delivery plans for the same day.
   Using the phone number as the delivery service user information written on the package label,
   “The number of digits above or below the number in the telephone number.”
   In order to register and lock the machine in advance, and have the delivery person unlock it based on the label of the package,
   instructions indicating the strength of the code are displayed around the mechanical lock.
   When the delivery person stores the package and closes the door, The door is automatically locked, so the door 3 can always be kept locked while waiting for the package to be received.
B: When using an electronic lock using short-range communication
   Electronic locks are effective when there are security concerns with the mechanical locks mentioned above (especially when receiving packages multiple times based on a phone number). Using short-range communication means 4e such as Bluetooth of the communication section of the remote locking/unlocking device 4d in the device 4c,
   a. Enable the drive unit to drive the deadbolt of the package receiving door 3.
   b. When there are multiple package scheduled for delivery on the same day. a phone number is used as the delivery service user information written on the package label,
      “a code of how many digits above or below the phone starting from a certain digit”
      is registered in advance and used to lock the package, and instructions on how to enter this code are displayed around the mechanical lock so that the delivery person can unlock the package based on the label on the package.
   By using these methods, the door automatically locks when the delivery person puts the package away and closes it, so the package receiving door 3 can always be kept locked while waiting for the package to be received.
   Next, the package receiving door unlocking application 50 is downloaded to the delivery person's communication terminal such as the smartphone 14, and as shown in the upper left of FIG. 2.
      \textcircled{1}. Follow the instructions of the application 50 and enter the tracking number on the label attached to the package into the smartphone (if the delivery person's smartphone 14 does not have a camera function)
      \textcircled{2}. Following the instructions of the application 50, the user uses the smartphone camera to read the encrypted barcode or QR code containing delivery information.
   By using either of the above methods, the tracking number on the label is recognized by the dedicated application 50.
   Then, the dedicated application 50 transmits the package information from the delivery person's smartphone 14 to the delivery service user's smartphone 6 via the IP network 23 in FIG. 2.
   And the dedicated application 50 in which the order information has been registered automatically performs the following check.
      \textcircled{3}. Does the tracking number on the label match the tracking number registered in the application?
      \textcircled{4}. Does the estimated delivery date information associated with the tracking number match the current date on the delivery person's smartphone 14?
      \textcircled{5}. Does the delivery address associated with the tracking number match the current location information on the delivery person's smartphone 14?
   If all of the above conditions are met,
      \textcircled{6}. The dedicated application 50 on the delivery person's smartphone 14 displays an unlock button and causes the delivery person to press the button to unlock the package receiving door 3.
      \textcircled{7}. After confirming that the above information matches, the dedicated application 50 automatically sends the unlock code to the package receiving door 3 to unlock it.
   Let the delivery person select one of the above options (in advance, the delivery person can set the application to prioritize safety or workability), open the package receiving door 3 and deploy the folding storage means.
   Set the door to lock automatically when you close the door after storing your belongings. (Either a normal mechanical auto-lock mechanism or an electronic auto-lock mechanism is acceptable)
   When the auto-lock mechanism operates, the short-range communication means 4e notifies the dedicated application 50 of the delivery person's smartphone 14 that the package has been received, and the notification is transferred to the dedicated application 50 of the delivery service user's smartphone 6 via the IP network 23 Confirm that the package has been received.
   In the above, the special application 50 is set so that traces of the unlock code are automatically erased from the delivery person's smartphone 14 after the package has been stored.
C: When unlocking an electronic lock with a time-limited code via an IP network Furthermore, if you want to improve security, you can use it temporarily only when unlocking each lock. An effective method is a time-limited unlock code method in which a possible password is issued to both the door and the delivery person to unlock the door.
   When using this method, it is assumed that the delivery service has an environment in advance to connect to the Internet with a home computer, and can communicate wirelessly with the router used for in-home communication and a wireless LAN such as Wi-Fi. By connecting to the communication device of the remote lock/unlock device 4d on the door side, a time-limited unlock code can be set on the door side via the IP network.
   In the present invention, the communication device section of the remote lock/unlock device 4d is configured to be able to add other additional communication means 4f in addition to the short-range communication means 4e.
   \textcircled{1}. Install a wireless LAN communication terminal such as Wi-Fi as an additional communication method 4f. and connect directly to the router.
   \textcircled{2}. A short-range communication repeater between the door and a location closer to the router on the indoor side. and connect to the router by using existing short-range communication means 4e.
   Since you can choose one of the devices and related equipment, you can change them according to conditions such as power consumption and distance to the router. In cases where wiring work is difficult and you want to run on batteries, or when the distance from the router is close. For such cases, it is preferable to choose the latter option \textcircled{2}.
   On the other hand, as an additional communication means 4f for temporarily storing a time-limited unlock code on the door side, a DECT communication terminal used in the conventional commercial product is used, and a DECT communication repeater is installed to connect the router and Wi-Fi. It is also possible to connect the door of the present invention to a wireless LAN such as a wireless LAN, which allows the door of the present invention to be connected to a home network of an existing product along with other devices such as a surveillance camera, similar to the conventional commercially available “communicable delivery box” mentioned above. It is also possible to incorporate it into
   In addition, if the building does not have a suitable communication environment and you want to connect the door directly to the IP network, you can add a SIM card communication terminal as an additional communication method 4f. Alternatively, a dedicated SIM card may be used to enable direct communication with other smartphones.
   In the configuration in which the lock is wirelessly unlocked using a time-limited code via various communication means as described above, unlocking is specifically performed using the following procedure and mechanism.
(1) When the delivery person arrives at the delivery destination, the delivery person takes a photo of the QR code on the label of the package with the delivery person's smartphone 14, and obtains at least a tracking number (such as a 12-digit inquiry slip number) assigned to the label. When this information is imported into the dedicated application 50, the time-limited unlocking code generated by the dedicated application 50 (or the package receiving agent) is remotely locked and unlocked via the remote locking/unlocking device 4d of the door at the delivery address and the router. It is temporarily stored in the storage unit of the device 4d.
   (Starts counting the required time from this point, and when the predetermined time elapses, sends a signal to erase this time-limited unlock code from the storage device.)
(2) The dedicated application 50 simultaneously transmits the same time-limited unlock code to the delivery person's smartphone 14, and allows the delivery person to unlock the door in one of the following ways:
   A. When the delivery person unlocks the door by pressing the unlock button displayed on the smartphone:
      (Set in advance if you want to prioritize security and have the delivery person recognize and unlock the door just in case)
   B. When the dedicated application 50 automatically unlocks:
      (Putting emphasis on the work efficiency of the delivery person, the package label is photographed, the dedicated application 50 sends a time-limited unlock code to the door via the IP network, and at the same time sends the unlock code directly to the door. Set in advance to automatically unlock the door.
   By using either of the two methods, mechanical lock and electronic lock, the delivery person that arrives at the delivery destination can unlock the package receiving door 3 and turn the package receiving door knob 5 without the delivery service user having to meet in person.
   FIG. 1(D) is a perspective view of the state in which the latch bolt 5a is retracted and the door is open at this time, and the package receiving door 3 has a dedicated locking/unlocking section 15.
   In this open state, the package receiving door latch bolt 5a is exposed, but the deadbolt is not on the dedicated locking/unlocking part 15 side, and its receiving seat part 5b is provided, which is used to connect the locking mechanism part to the entrance/exit door. This is to promote downsizing and cost reduction by consolidating the parts on the side.
   (In addition, the “dedicated applications 50” mentioned above may be sold for a fee to delivery service users, delivery companies, mail order companies, etc., or billed for use each time after being distributed free of charge on the Internet, or billed on a fixed-rate basis.)

### <Expansion of the Storage Compartment Behind the Package Claim Door and Package Storage>

On the other hand, on the storage side behind the package receiving door, there are 7a and 7b of the four side separators 7a and 7b of the storage means 16, which are folded next to the entrance/exit door frame in this perspective view, and their hinge portions 17 (In this case, a part of the back side separating plate 7e and a storage means handle 18 for push-out and pull-back operations are exposed in the center.
(Here, the storage compartment is made up of a total of six isolation boards on the left and right rear sides and the back of the package receiving door, but the number of boards is not limited to these, and the number of boards can be increased. You can further expand the size of the storage compartment by making it slideable, add a top plate, roll-up awning, floor board, roll-up floor sheet, etc. in the vertical direction, or add a bag-shaped or bellows-shaped bag made of cloth. It may be made into a foldable storage box, and its material may be metal plates such as aluminum or stainless steel, or glass, carbon fiber, or fiber reinforced resin such as cellulose nanofiber to make it thinner and lighter.)

Around the doorknob of the lock/unlock frame 2 of the entrance/exit door, there is a sign to explain to the delivery person how to store the package. Press the front storage means handle to unfold the left and right folding separators into the entrance. After completing the storage, store the package and close the package reception door 3. hen the delivery person completes the work, the package receiving door 3 is automatically locked, and the dedicated application 50 of the delivery service user's smartphone 6 is notified that the delivery service user has completed receiving the package.

The opening/closing operation of each door and the opening/closing operation of the storage compartment described above will be supplementarily explained using horizontal cutaway top views of the central part of the deadbolt 4b in FIGS. 1(E) and 1(F).
A. In the state shown in FIG. 1(A), each door, deadbolt, and storage means are connected as shown in FIG. 1(F). is located,
   (1) The dead bolt 4b for the entrance/exit door in the lock/unlock device 4c has a receiving seat portion 4b′ fixed in the position where it penetrates
   (2) The dead bolt 5b for the package receiving door is the receiving seat part 5 on the side of the package receiving door. Fixed at the position where it enters 5 b′
B. In the state of FIG. 1(E) after the storage section is expanded, each door and lock are connected as shown in FIG. 1(G), the storage means is arranged.
   (1) The deadbolt 5b of the baggage receiving door is moved into the locking/unlocking device 4c. The baggage receiving door 3 is unlocked and opened (the force required for pushing and expanding is adjusted between 20 N and 40 N).
   (2) The delivery person presses the handle 18 of the storage means exposed at the front, and the partition plates 7a to 7e connected by each hinge part 17 move to the back side of the entrance by the opening and closing operation, and the storage area surrounded by each plate is expanded, and these states are maintained.

### <Monitoring of Package Storage Work and Notification of Status Inside Storage>

An illuminated camera 20 is also provided above the storage means exposed behind the package receiving door in FIG. 1(D) described above. (Here, it is installed on the top of the back side separation plate 7e so that it can take pictures diagonally downward, but it is preferable to use a spherical camera.)

This camera makes it possible to monitor and record the work of the delivery person after unlocking the door for receiving the package, among the following tasks.
(A) First, as shown in the upper left of FIG. 2, a delivery person that has arrived at the locked entrance/exit door 1 uses the delivery person's Using a dedicated application 50, the smartphone 14 can check delivery information by using the camera of the smartphone 14 to read the QR code 21 (or a barcode) that is attached to the label affixed to the package 21 by the mail-order company or delivery company.
(A) The dedicated application 50 recognizes the delivery address from the order or delivery information in the QR code 21′ and compares it with the current location information of the smartphone detected by the GPS signal from the GPS satellite 22 in the upper center of FIG. 2.
(B) The dedicated application 50 uses the order or delivery information from the QR code 21′ to check the delivery address. This information is then compared with the smartphone's current location information detected by the GPS signal from the GPS satellite 22 shown in the upper center of FIG. 2.
(C) If the delivery address and the current location of the smartphone match, the delivery person's smartphone 14 The information “Delivery person has arrived” is sent exclusively to the IP network using remote communication means. at the same time as sending a request signal to unlock the package receiving door 3.
(E) These signals are received by the communication terminal of the delivery service user's smartphone 6 via the dedicated application 50 and are then sent to the delivery person's smartphone 14 in one of following two ways (the delivery service user can choose at their discretion depending on the importance of the package, etc.)
   a. Does the delivery service user send a signal to unlock the parcel receiving door 3 to the delivery person's smartphone 14 via the dedicated application 50
   b. Does the dedicated application 50 automatically send a signal to unlock the parcel receiving door 3 that has been registered in advance directly to the delivery person's smartphone 14 (which the delivery service user can select at their discretion depending on the importance of the package, etc.), and when the delivery person presses the “package receiving door unlock button” via the dedicated application 50, the package receiving door 3 is unlocked via the short-range communication means 4e between the delivery person's smartphone 14 and the entrance/exit door 1. The delivery service user can arbitrarily select either method \textcircled{1} or \textcircled{2} depending on the importance of the package, send it to the delivery person's smartphone 14, and use the dedicated application 50 to deliver the item.
   (Or, Alternatively, if the delivery person agrees to leave all of these steps to the dedicated application 50, the delivery person can simply take a picture of the QR code 21′ on the label attached to the package 21 with the smartphone 14, and all subsequent steps after the picture is imported into the dedicated application 50 can be omitted, and the package receiving door 3 can be instantly unlocked.)
(E) The delivery person pushes out the handle 18 of the folding compartment that was exposed after the above unlocking. After unfolding and forming a storage compartment 19 inside the entrance, package is stored.
(F) After storing the package, when the delivery person closes the package receiving door 3, the door is automatically locked. At the same time, the “package reception & locked complete” signal is activated remotely for entrance/exit door 1. It is transmitted from the lock device 4d to the delivery person's smartphone 14 via short-range communication.
(G) This “package received and locked” signal received by smartphone 14 is sent to the delivery service user's smartphone 6 via the IP network 23.

Completion of package reception is confirmed through the following steps, but the situation inside the storage at this time is monitored by the camera 20 as shown in the top view at the bottom left of FIG. 2, and the status after package storage is monitored as shown in (1). In addition to being able to monitor the situation in real time from when the package receiving door 3 is opened as shown in (2) until it is locked again as shown in (1), the storage device in the delivery service user's smartphone 6 is also possible. The images during this time are saved on the cloud server 25 of the cloud server 25, and can be checked later.

In addition, in the above package receiving process, if the delivery service user is busy on the go, the package receiving agency 24 contracted in advance (dedicated application developer, security company, etc.) can monitor the package receiving process and use the existing method. It is also possible to take immediate action in the event that suspicious behavior such as package removal is detected.

<Realization of Non-Face-to-Face Package Delivery Service from Home>

Furthermore, in the present invention, by using the above-mentioned built-in camera and making it possible to provide this image information to the delivery person at any time via the dedicated application 50, it is possible to efficiently grasp the state of the packages stored in the storage. It is also possible to facilitate delivery as follows.
(1) The lighting function of the camera allows you to see the inside of the storage compartment with the package claim door closed.
   Since it is also possible to observe the condition, this image information can be sent to the delivery person via the dedicated application 50. be made available to the public at any time.
   (To protect privacy, only the outline image of the package is displayed instead of the raw image or it may limited the text processing such as mosaic processing to the text)
(2) When a delivery person prepares to deliver a new package, the delivery person can photographed inside of the target delivery box in advance by the camera 20, using the dedicated application 50 with the smartphone 14.

By selecting the pre-set item in the dedicated application 50 “Delivery destination storage status”, a real-time image of the storage for the entered delivery plan (which may be an image with the above restrictions) can be confirmed. Then, by the following two ways to estimate the space occupied by the package s inside the box.
a. The delivery person visually estimates the available space for the package to be delivered.
(For this reason, a scale for estimating dimensions is added in advance in the length and width of the storage.)
b. The dedicated application 50 calculates the available space based on image analysis and measurement data from the distance sensor and displays it on the screen as reference information.

From this information, the delivery person can determine whether to deliver the target package,
\textcircled{1}. Deliver it immediately
   or,
\textcircled{2}. Postpone it until the next time there is available space.
   By using the above method, a new effect of preventing the delivery person from making unnecessary redeliveries can be obtained.
   <Realization of Non-Face-to-Face Package Delivery Service from Home>

In addition, by utilizing this device and system described above, delivery service users will be able to create a new form of service usage in which delivery service users can collect packages that they wish to request a delivery person to deliver while they are away, in a non-face-to-face manner. It is also possible to develop.

In other words, the delivery service user can requests the delivery company to pick up the package from users home in advance.
a. Using the mechanical lock case:
   Set a new unlock code for the mechanical lock and communicate that code to the delivery company by telephone, E-mail, etc.
b. Using the electronic lock case:
   After registering the unlock code in the electronic lock in advance and also registering it in the dedicated application 50, when the delivery person arrives at the user's home, smartphone 14 and has the dedicated application 50 check the current location information of the smartphone 14. When you press the “Collection door unlock request signal” button. Send the memorized unlock code to the short-range communication means 4e of the package receiving door 3 via the short-range communication means of the smartphone 14 to unlock it.

Using either a mechanical lock or an electronic lock, the delivery person arriving at the scene can open the package receiving door 3 and collect the package stored inside without face-to-face contact with the delivery service user. It will be. (In this case, payment for the shipping fee should be made by credit card etc. at the time of ordering)

The features of the new configuration of the first invention and the features of the system allow the delivery service user to “promote the effective use of the space around the entrance”, “no wasted space when there is no package receiving area”, and “nearly the same height as the entrance door, A large storage compartment with a depth equal to the frontage width and width of the opening can be created by simply replacing the door”, “The storage compartment can be opened by simply pushing out or pulling out, without the need for complicated assembly,” and “Waiting for package receipt”, “It is possible to receive package multiple times without face-to-face contact while you are away”, “It is possible to prevent the delivery person from making unnecessary deliveries and redeliveries”, and “from home. In addition to solving the problems of conventional delivery boxes.

### Second Embodiment

FIG. 4 shows an overview of the package receiving and storing device in the second embodiment of the present invention according to the difference in the usage state, the structure explanation, and the waterproofing reinforcement configuration of FIG. 4(A) to (F). In contrast to the configuration in the first embodiment where the folding storage section is pushed forward, this embodiment is characterized by the opposite configuration where it is pulled forward and used. While the former is suitable for use with outward opening doors, which are relatively common in Japan, the configuration of this embodiment is suitable for use with inward opening doors, which are relatively common in Europe and the United States (for other sliding doors that slide left and right, it can be installed either inside or outside as long as there is room in the door pocket). A detailed explanation will be given below along each of FIG. 4(A) to (F).

### <Opening and Closing of Entrance Door>

FIG. 4(A) is a perspective view of the closed state of a drawer-type door with a package receiving storage unit, which is the package receiving and storage device of the present invention. The operation for opening the entrance door 1 is the same as in the first embodiment, so it is omitted.

### <Opening and Closing of Package Receiving Door>

In this embodiment, a drawer-type package receiving door 26 is used to open and close the package receiving door, and a separate locking and unlocking device 4c′ for the package receiving door is required in addition to the locking and unlocking device 4c of the first embodiment, but when the delivery service user himself locks and unlocks the door, he can use any of a physical key, a variable dial lock, or wireless communication.

However, in this embodiment, before unlocking the package receiving door, it is first necessary to unfold the package receiving door to the storage state, and for this purpose, as shown in the enlarged view of the door knob in FIG. 4(B), a package receiving door separation/entrance doorknob 27 is used. When opening the entrance door for entrance/exit, the knob is rotated to the right to store the entrance/exit door latch bolt 27a in the direction of the right arrow in the figure, and the entrance/exit door is opened. When the delivery person that has arrived at the site is to store the package, in order to have the delivery person separate the drawer-type package receiving door 26 from the entrance/exit door 1, the package receiving door separation/entrance doorknob 27 is rotated to the left and stored in the direction of the left arrow in the figure to store the door separation latch bolt 27b, and after making it possible to separate it from the entrance/exit door 1, the handle 18′ must be pulled forward to unfold the drawer-type package receiving door 26 as shown in FIG. 4(C). To facilitate this operation and reduce the weight burden on the door hinge, in this embodiment, casters 29 are provided on the lower part of the front frame of the storage. (A cover explaining the above work contents is also provided on the door surface.)

In this embodiment, in order to form a package receiving storage outdoors, in addition to unfolding the folding panels to the left and right in FIG. 4(C), a bellows-type waterproof cover 28 is set to be unfolded with the pull-out operation to prevent rain from entering from the top. In addition, in order to increase the rigidity of the storage so that it can withstand strong winds from outside, as shown in the rear perspective view of the folding storage section in FIG. 4(D), in addition to the left and right folding panels, a top panel 7f and a floor panel 7g are provided that can be unfolded in the white arrow direction in addition to the left and right folding panels, and while the left and right separator panels are unfolded forward, they are unfolded up and down by pressure members such as torsion recoil springs (not shown) centered on each of the rotation shafts 7h and 7i, and finally, the upper ends of the left and right separator panels and the upper and lower frame ends on the front side of the package receiving door are integrated by fitting with the protrusions and grooves (not shown) provided between the left and right and front ends of the top panel and floor panel, forming a box-shaped shape to ensure rigidity.

Next, in order to achieve the objective of “having the delivery person open the package receiving door built into the door and then unfolding the folding storage means inside to store the package”, which is a feature of the present invention, there are two ways to have the delivery person open the unfolded package receiving door: using a mechanical lock such as a dial or keypad lock, as in the first embodiment, or using an electronic lock. In this embodiment, the difference is that the locking/unlocking device 4c′ installed on the unfolded package receiving door side can be used, but either method can be basically similar and can be used to unlock the door.

In this embodiment, as shown in the figure, the type of surface door of the drawer-type package receiving door 26 is a folding door type, in which the unlocked doorknob is slid to the right and the surface door panel is folded into four parts to open. This is to avoid the situation where, when there is not enough space in front of the entrance, a normal cantilever hinged door restricts the angle at which it can be opened and closed, making it difficult to ensure a sufficient opening for storing package. Needless to say, in addition to the folding door shown in the figure, a shutter door that rolls up or slides left and right may also be used.

In addition, in this embodiment, a bellows-type waterproof cover 28 is provided to cover the ceiling and part of the surrounding side surfaces as a waterproofing measure for a storage cabinet deployed outdoors, but a bellows-type storage cabinet 30 that covers the entire side surface of the storage cabinet may also be used as shown in FIG. 4(F), and furthermore, in addition to the bellows type, a bag-type storage cabinet 30′ may be used as shown in FIG. 4(G) in which a space capable of storing a cloth-like material is provided between the separator plate. In these cases, it goes without saying that the internal folding storage material does not necessarily have to be plate-shaped, and may be constructed of a pipe-frame-shaped folding storage material.

### Third Embodiment

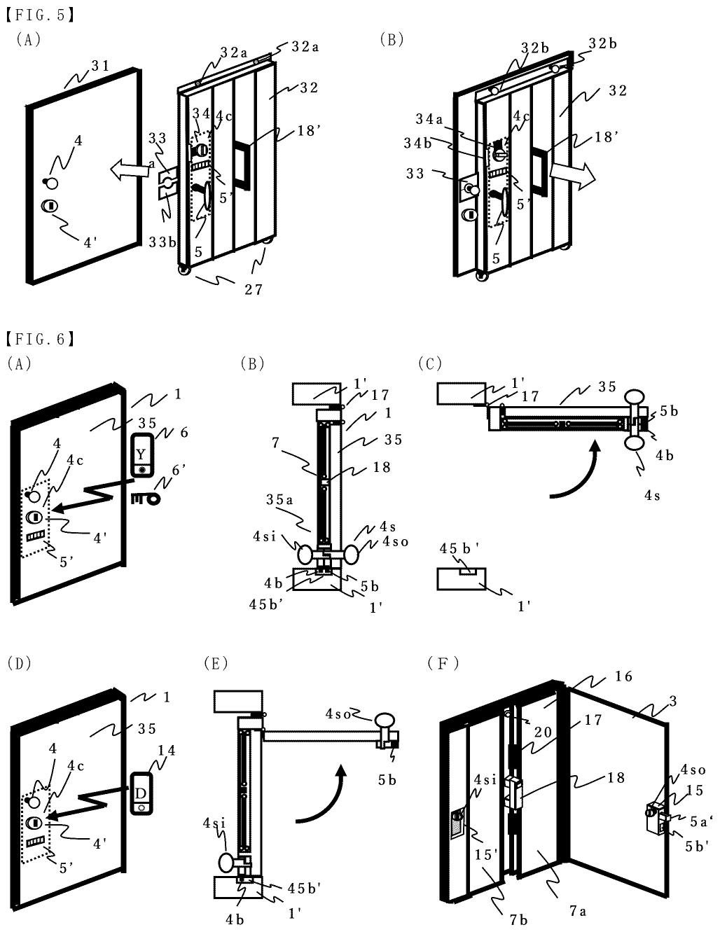

FIG. 5 shows an overview of the package receiving and storage device in the third embodiment of the present invention, which aims to realize the same function of a drawer-type package receiving door as in the second embodiment by retrofitting it to the surface of an existing door, in the explanatory diagrams of the states before and after the retrofit door is installed in FIGS. 5(A) and (B). The feature of this embodiment is that the basic configuration of the package receiving door part in the second embodiment is consolidated into an independent package receiving door unit, and a retrofit drawer-type package receiving door 32 is separately created to realize the same function by retrofitting it while leaving the existing door in place.

In this embodiment, as shown in FIG. 5(A), the retrofit drawer-type package receiving door 32 is abutted against the surface of the existing door 31,
(1) First, the upper fixing member 33a and the lower fixing member 33b of the doorknob clamping fixing member 33 are adjusted vertically and horizontally to the doorknob 4 of the existing door 31, and then the doorknob is clamped after adjusting the shaft diameter of the doorknob (preparing attachments with multiple outer diameters, etc.)
(2) Next, the retrofit drawer-type package receiving door 32 is attached to the existing door with double-sided tape (not shown) provided at least at the four corners of the back surface of the retrofit drawer-type package receiving door 32. a) abut the back surface of 32
(3) If the degree of adhesion is insufficient, it may be further fixed by screwing using fixing screw 32b as shown in FIG. 5(B) through screw hole 32a provided in the upper part of the retrofit drawer-type package receiving door 32 (in this embodiment, a configuration in which screws are fastened from the outside is shown to make the configuration easier to understand, but in reality, it is preferable to screw from the inside with the package receiving door unfolded and open, both in terms of crime prevention and application, and similarly, when fixing the doorknob clamping fixing member 33, it is preferable to do so from the inside with the door open).
(4) After the close contact, the lever 34a of the drawer fixing means 34, which is composed of the drawer fixing lever 34a and the drawer fixing hook 34b provided at the upper left of the retrofit drawer-type package receiving door 32, is turned to the right to remove it from the hook 34b, and the handle 18′ is pulled in the direction of the white arrow to unfold the folding storage section.

In this manner, the delivery person can store the package in the same manner as in the second embodiment, and in this embodiment, the package receiving means is retrofitted to the existing door 31, and it is possible to realize a package receiving means having the same function as the second embodiment at a lower cost while leaving the existing door in place.
(However, in the second embodiment, as in the first embodiment, after receiving the package without meeting the delivery person while at home, the door of the partition on the inside of the room can be opened to access the package without going outside, but in order to add this function in this embodiment, a special attachment and detachment means must be used for the inward-opening door, so this is omitted.)

### Fourth Embodiment

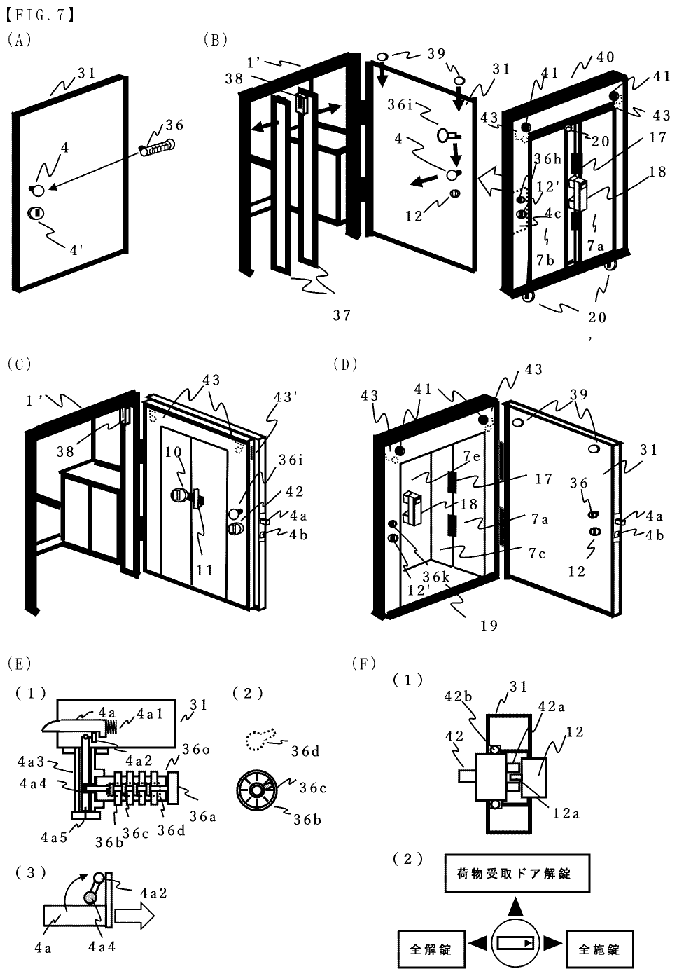

FIG. 6 shows an overview of the package receiving and storage device in the fourth embodiment of the present invention according to six different usage states and observation directions from FIG. 1(A) to (F), and will be described in detail below with reference to each of FIG. 6(A) to (F).

### <Opening and Closing of Entrance Door>

FIG. 6(A) is a perspective view of the package receiving and storage device of the present invention, with the door with package receiving and storage unit closed, and the delivery service user is about to open the entrance door 1 to enter and exit. The same parts as in the above embodiments are omitted, but in this embodiment, a new configuration is used as the door opening and closing mechanism that uses one door instead of two doors, so the opening and closing of the entrance door 1 will be described below using FIGS. 6(B) and (C), which are top cross-sectional views of the deadbolt of the locking and unlocking part when cut horizontally at the center.

FIG. 6(B) shows the door closed and locked. The main differences from the first embodiment are:
(1) There is only one front door, the full-length package receiving door 35, which is used for both entrance and exit
(2) There is only one doorknob, which has been replaced with a separate doorknob 4s that can be separated at the center into an outer knob 4 so and an inner knob 4si, and is weakly joined only by the action of a magnet (not shown) located at the center
(3) The actual entrance and exit function is performed by an entrance and exit restriction plate 35a with storage means at the back and so on. With these changes, there are the following advantages in cost and application:
   a. Only one door plate and doorknob are required
   b. The locking and unlocking device can be consolidated in one place.

Therefore, in order to enter or exit in this embodiment, in FIG. 6(B), the deadbolt 5b locking the front package receiving door 35 and the deadbolt 4b locking the access restriction plate with storage means 35a are simultaneously driven to be stored on both door sides from the shared deadbolt receiving seat 45b′ in the door frame 1′ using a mechanical lock or electronic lock, and the doorknob 4s is turned to remove the latch bolt (in this embodiment, the single latch bolt 5a on the front door side serves both purposes), and the two doors can be opened as a single unit as shown in FIG. 6(C) for entry or exit.

### <Opening and Closing the Package Receiving Door>

Next, when the package delivery person arrives at the delivery destination and wants to open the front package receiving door 35, it is unlocked mechanically or electronically as in each of the above embodiments,
(1) Only the deadbolt 5b is driven to be stored from the shared deadbolt receiving seat 45b′ to the front package receiving door 35 side,
(2) The delivery person turns the doorknob 4 so to remove the latch bolt 5a and pull it toward themselves,
(3) The deadbolt 4b remains in the shared deadbolt receiving seat 45b′. Since the doorknob 4s is fixed in place, the doorknob 4s, which is connected by the magnetic force in the center, comes off at the center, and only the doorknob 4s moves together with the front package receiving door 35 to open as shown in FIG. 6(E).

After this process, the internal folding storage means is exposed as shown in the perspective view of FIG. 6(F), and next to it, there is a hole for the tip of the inner doorknob and a groove for storing the automatic unlocking mechanism from the bottom. The subsequent work is the same as in the first embodiment, so it will be omitted.

As described above, in this embodiment, which can combine the doorknobs into one, if the doorknobs remain integrated, when only the full-front package receiving door 35 is opened, a hole will be created in the doorknob around the locking part of the remaining entrance and exit restriction plate 35a with storage means, and the inside of the entrance will be visible to the carrier. Therefore, the doorknob is configured to separate in the center so that no hole will be created. As a means of providing this separation function, magnets are attached to the joints of the inner and outer doorknobs, and they are joined so that they can be attached and detached by magnetic force. The strength range of the force required to separate them is set to about 20 N to 40 N in this embodiment, because if it is too light, there is a risk of them separating even when entering and exiting, and if it is too strong, problems such as wasted effort when opening and closing the door when storing package and increased work burden will occur. (However, it goes without saying that in order to achieve the purpose of this invention, a joining method other than joining by magnetic force may be used, and it is also possible to add a separate structure to block the hole in the doorknob without making the doorknob separable in the first place.)

### Fifth Embodiment

FIG. 7 shows an overview of a package receiving and storing device in the fifth embodiment of the present invention for retrofitting a package receiving and storing function to the inside of an existing door while leaving the existing door 31 as in the third embodiment. The device is explained in four different usage states in FIG. 7(A) to (D), and the structure of the additional members is explained in FIGS. 7(E) and (F). The detailed explanation will be given below along with FIG. 6(A) to (F).

### <Preparation>

In this embodiment, in order to retrofit a package receiving and storing function to the inside of an existing door 31, first, as in the fourth embodiment, as shown in FIG. 7(A), the doorknob 4 of the existing door is replaced with a separate type doorknob 36 with a dial lock, which can be separated in the center and has an outer knob 360 with a variable dial lock on the outer knob and an inner knob 36i with a keyhole for switching between three states on the inner knob.

Here, the main internal structure of the outer knob 360 with variable dial lock is as shown in the upper cross-sectional view of the dial lock part in FIG. 7(E)(1), and is composed of the latch bolt 4a, which is always held in a protruding state by the pressure spring 4al of the existing door 31, the rotating arm 4a2 for pushing it back in the retracting direction, the rotating shaft 4a4 for transmitting a rotating force to the rotating arm, the variable dial lock pin 36a for inserting into the hole groove of the rotating shaft 4a4 to transmits a rotating force, the variable dial handle part composed of the unlocking code setting piece 36c and the unlocking guide groove 36d, etc., and the door knob cylinder 4a3 which has a keyhole 4a5 at the front end and contains the variable dial lock and the rotating shaft.

### <Unlocking Operation of the Combination Lock by the Delivery Person>

The dial part is held in a horizontal position by the reaction force of the pressure spring 4al, and the partition grooves (in this embodiment, for convenience, they are divided into 8 directions, and the corresponding dial surfaces are engraved with numbers “0 to 7”) formed radially inside the dial as shown in (2) of FIG. 7(E),
(a) In advance, with the variable combination lock pin 36a returned to the right side, the dial is adjusted to the unlocking code so that the unlocking code setting piece 36c matches the shape of the unlocking guide groove 36d
(b) In this state, when the variable combination lock pin 36a is pushed to the left, it becomes the state shown in (1) of FIG. 7 (E), and the unlocking code setting piece 36c slips through the unlocking guide groove 36d and the entire pin slides to the left
(c) The slid pin is inserted into the groove of the rotating shaft 4a4, and the rotating shaft and the pin become one. (d) After that, when the entire handle with the dial is rotated downward from the horizontal position, the rotating arm 4al rotates so that the internal rotating shaft pushes the latch bolt 4a to the right, and the latch bolt of the door is released, allowing the door to be opened and closed. (Note that this rotating shaft 4a4 is of course also connected to the inner knob 36i.)

After going through these steps, the delivery person can dial the unlock code according to the delivery service user's instructions, as in each of the above embodiments, move the variable dial lock pin 36a to the left, and turn the dial handle to open the door.
(However, even in this configuration, there is a concern that the doorknob size will become larger if a complex mechanism is built in that automatically returns the variable dial lock to its initial position such as “0000” when the door is closed, so it is preferable to display an operation instruction to the delivery person stating, “After closing the door after storing the package, return the slide pin to its original position and return the dial position to “0000”)
   <Procedure for Retrofitting Entrance and Exit Restriction Plate with Storage Means>

Next, as shown in FIG. 7(B), the left and right building retrofit plates 37, which have building side fixing members 38 at the left and right upper ends for fixing the retrofit entrance and exit restriction plate with storage means 40 to the building, are glued or screwed to the left and right door frames of the building, or fixed with spring pressure that applies pressure in the vertical direction, and door side fixing members 39 for fixing the retrofit folding storage means door 40 to the existing door 31 are screwed to the left and right upper parts of the back of the existing door, and the doorknob 4 is removed and replaced with an inner knob 4si only on the inside.

Furthermore, in order to attach the retrofit folding storage means door 40 to the existing door side, it is moved from the state shown in FIG. 7(B) in the direction of the white arrow, turned over,
a. The door side fixing hole 41 fixed to the existing door is inserted into the door side fixing member 39
b. The attachment/detachment switching hooks 43 at the upper left and right ends of the retrofit folding storage means door are rotated inward to join to the door side fixing member 39
c. At the same time, the inner knob 36i is passed through the door knob through hole 4sh provided on the folding storage means door 40 and fixed
d. At this time, the thumb turn 12 of the existing door is fitted into the thumb turn receiving groove 12′ provided on the opposing surface of the retrofit folding storage means door 40

The result of fixing the retrofit folding storage means door 40 to the existing door side in this procedure is shown in the perspective view of FIG. 7(C).

In the perspective view of FIG. 7(C), the interior surface of the rear-mounted foldable storage door 40, which is fixed to the back side of the existing door, is exposed, and a door that allows package to be received from the interior side is formed, basically the same as in the first embodiment, but the inner doorknob is the inner knob 36i for the variable combination lock, and the thumbturn part also abuts against the surface of the existing thumbturn, and is extended by operating from the inner surface of the rear-mounted foldable storage door 40, making it possible to switch between the two states of lock and unlock with the extension operation of the existing thumbturn, and further, the rear-mounted foldable storage door 40 can be
A: Should it be fixed to the existing door side?
B: Should it be fixed to the building side?
(The left and right detachable switching hooks 43 are rotated so as to be inserted into the grooves of the building-side fixing member 38)
   These combinations allow for a third state to be realized in which, in addition to the two conventional states of locking and unlocking the existing door, the retrofit folding storage means door 40 is fixed to the building side even if the existing door is unlocked, making it impossible to enter or exit, allowing the existing door to function as a package receiving door.

The three-state thumb turn 42 used at this time abuts against the front side of the existing thumb turn 12 as shown in the side cross-sectional view of FIG. 7(F)(1), and the knob protrusion 12a of the existing thumb turn 12 is pinched between two claws 42a, allowing the three-state thumb turn 42 provided on the interior side of the retrofit folding storage means door 40 to be turned and extended. In order to reduce the operating resistance of the extended thumb turn in this embodiment, a bearing 42b is placed in the rotation receiving portion, and labels indicating the three-state switching positions as shown in FIG. 7(F)(2) are attached around the three-state thumb turn 42 to prevent erroneous operation of the somewhat complicated locking and unlocking.

The meaning of “fully unlocked” when turned all the way to the left in these three states is that the retrofit folding storage means door 40, which is fixed to the building side, has been fixed to the existing door side by rotating the detachable switching hook 43. Prior to that, when the existing thumb turn was turned to the center position to be in the unlocked state, the existing door that functions as the package receiving door was in the unlocked state, and if an attempt is made to rotate the three-state switching thumb turn 42 further to the left, the claw 42a stops there because the existing thumb turn cannot rotate any further, and the surface unit part of the three-state switching thumb turn 42 is detached from the claw 42a, and only the surface unit part rotates, and as a result of this rotation, the detachable switching hook 43 is rotated via a wire or link mechanism, in the case of a mechanical type, and is detached from the building side fixed member 38 and fixed to the door side fixed member 39, meaning that both doors are in a fully unlocked state where they can be accessed as one.

Therefore, in this embodiment, when a delivery service user goes out on a day when he or she is scheduled to receive a package, the user first sets the three-state switching thumb turn 42 to the fully unlocked position and goes outside the door, and then inserts and turns a special key into the three-state switching keyhole 36k exposed on the surface side of the inner knob 36i for the inner knob variable combination lock, which is exposed at the doorknob hole position on the surface of the retrofit folding storage means door 40, or uses an electromagnetic lock to set the knob to the “package reception door unlocked” position, which is the center position of the three states (i.e., the thumb turn of the existing door is in the unlocked state), and then closes the existing door, and the user sets the three-state switching keyhole 36 with the variable combination lock on the retrofit folding storage means door 40. After fixing 40 to the door frame on the building side,
(1) When using a mechanical lock, leave the existing door unlocked, set the unlock code shared with the delivery person on the door knob dial, and go out
   (At this time, due to the function of the variable combination lock, if the unlock code does not match, the rotation force of the door knob is not transmitted to the latch bolt, so the latch bolt cannot be stored on the door side and functions as a deadbolt)
(2) When using an electronic lock, the variable combination lock is not used, and the existing deadbolt and detachable switch hook 43 can be locked and unlocked wirelessly, making it possible to receive package in the same way.
   (It is also possible to operate the variable combination lock wirelessly, but installing the components inside the doorknob would result in the doorknob becoming larger, so this is not adopted)

With either method, it is possible to obtain the same improvement in convenience and reduction in waste in receiving package as in each of the previous embodiments.

As described above, by using the device of the present invention, it is possible to effectively utilize the space around the entrance as a means for receiving and storing delivered packages, and at least when there is no package to be received, without wasting space, and a large storage unit with a height and width similar to that of the entrance door and a depth equivalent to that width can be realized by simply replacing or installing the door, and no complicated assembly work is required, and the storage unit can be deployed by simply pushing or pulling out the door, and even with a mechanical lock, it is possible to prevent tampering while waiting to receive the package, and it is also possible to receive packages multiple times without meeting the recipient while the recipient is absent.

In addition, by using a system that utilizes the communication means and application of the present invention to make the most of the device of the present invention that can store large packages, it is possible to prevent unnecessary redelivery by the delivery person, and conversely, it is possible to have the delivery person collect the package without meeting the recipient when sending it from home, thereby solving the problems of conventional package locks and realizing new service uses.

### EXPLANATION OF SYMBOLS

1. Entrance door
4. Door knob
4d. Remote locking/unlocking device
4d3. Communication unit
5. Door knob for receiving package
5′. Variable combination lock
6. Smartphone of delivery service user
7c. Rear separator
8. Magnetic metal plate
9. Magnetic plate
10. Lock lever
11. Hook
14. Smartphone of delivery person
20. Illuminated camera
21′. QR code
23. IP network
25. Cloud server
50. Dedicated application

1. A package receiving and storage device that is characterized in that the entrance and exit door is provided with a package receiving door and a folding storage means at the back of the package receiving door that can be expanded by pushing or pulling out a storage compartment, and when receiving package, the entrance and exit door is left locked and the delivery person unlocks the package receiving door, and the storage means is expanded to store the package in the storage compartment that is formed.

2. In the device of claim 1, the package receiving door has a package receiving doorknob, package receiving locking and unlocking means, and package receiving hinges, and the storage compartment has a height and width that are the height and width of the entrance and exit door excluding the locking and unlocking part of the entrance and exit door and the door frame part, and can form a depth that is greater than or equal to the width.

3. In the device of claim 1, the surface door of the entrance door also serves as the package receiving door, and a separate doorknob that separates into two parts, an inner one and an outer one, when the outer knob is pulled while the inner knob is fixed, and an entrance/exit restriction plate having the storage means is provided on the back of the surface door, and when entering or exiting, both the locking/unlocking means for the entrance/exit restriction plate and the surface door are unlocked, and the outer knob and the inner knob are integrated to enter or exit, and when receiving package, the entrance/exit restriction plate is locked, the surface door is unlocked, the separated surface door with the outer knob is opened, and the exposed folding storage means is unfolded to store the package.

4. A package receiving and storage device according to claim 3, characterized in that an entrance and exit restriction plate with a retrofit storage means is provided on the interior side of the existing door, a building side fixing member for fixing the retrofit entrance and exit restriction plate to the left and right door frames of the building, and an existing door side fixing member for fixing the retrofit entrance and exit restriction plate to the existing door are provided, a fixing joint switching means is provided inside the entrance and exit restriction plate, the existing doorknob is replaced with a detachable doorknob with a variable dial lock that has a function of switching the transmission of rotational force to a latch bolt, a rotatable claw member is abutted against the surface of the entrance and exit restriction plate facing the existing door by sandwiching the knob part of the existing thumb turn, and a second thumb turn is provided that has a function of extending and rotating the claw member from the interior side of the entrance and exit restriction plate and a function of switching the fixing joint of the entrance and exit restriction plate.

5. A package receiving and storage device according to claim 1, characterized in that in each of the above devices, an interior opening and closing means that can be opened and closed only from the interior side is provided on the inner rear wall panel of the storage wall after the folding storage means of the package receiving door is deployed.

6. A package receiving and storage device according to claim 1, characterized in that the package receiving door is a package receiving door with a built-in drawer-type folding storage means that is attached to the outside of the existing door by gluing, screwing, belt fastening, connecting and fastening to the existing doorknob, or a combination of these.

7. A package receiving and storage device including the devices of claim 1, in which, as a means for unlocking the package receiving door by a delivery person, an instruction unit is provided that instructs the delivery person to input the tracking number given on the label of the package or the number of the delivery service user's telephone number, which is a number of predetermined digits from a predetermined digit position in a predetermined digit direction, as an unlocking code in a variable-type mechanical lock and then locks the door, as a PIN code, after which the delivery person unlocks the code-entered mechanical lock in accordance with the instructions of the instruction unit to store the package, and then closes the door, whereby the door is automatically locked.

8. In a package receiving and storing device including each of the devices of claim 1, a wireless locking/unlocking means having a power supply unit, a communication unit, a control unit, a memory unit, and an actuator drive unit is provided, and an application dedicated to operating the wireless locking/unlocking means is distributed on the Internet, and both the delivery service user and the delivery person register the dedicated application using a communication terminal with a long-distance communication means, and when the delivery person arrives at the delivery destination,
either inputs the necessary information via the application or reads the code information attached to the package with the communication terminal,
the application automatically transmits the package receiving door unlock request signal to the communication terminal of the delivery service user via the long-distance communication means,
and the delivery service user who receives the signal transmits an unlock signal via the application,
or the application automatically compares the package information, location information, and order information of the delivery service user, and automatically transmits the unlock signal when the necessary information matches,
After sending an unlock signal to the communication terminal of the delivery person via the long-distance communication means, the dedicated application sends an unlock code to the package receiving door by the short-distance communication means of the communication terminal of the delivery person to unlock the package receiving door, and then deletes the unlock signal data from the communication terminal of the delivery person, or a long-distance communication means is also added to the communication unit of the wireless locking/unlocking means, and the application sends a time-limited unlocking code, which is differentiated using a pseudo-random number or the like, to both the wireless locking/unlocking means and the communication terminal of the package deliverer via the long-distance communication means, and the wireless locking/unlocking means unlocks the package receiving door only if both unlocking codes match within the time limit,
After storing the package in one of these ways, when the package receiving door is closed, it is automatically locked, and at the same time, a receipt completion notification is sent to the delivery service user via the application.

9. In the device and system of claim 8, a lighting means and an imaging means or an imaging means and a distance sensor are provided above the storage means, and image information of the delivery person storing the package via the application is distributed to the delivery service user while the images are stored on the communication terminal or cloud server, and the delivery person can also obtain image information of the delivery destination storage facility one by one via the application when preparing for delivery of the package, and based on the image information,
the delivery person can recognize the space occupied by existing packages in the storage facility and determine whether the next package to be delivered is of a size that can be added,
or, based on the image information or the image information and distance information, the calculation function of the dedicated application or the calculation device of the application development company can be used to notify the space occupied by existing packages in the storage facility and the size of the package that can be added,
the package receiving and storage device and package receiving system are characterized in that the delivery person can be provided with information to determine whether new packages can be added before delivery via the dedicated application.

10. A package receiving and storage device and a package receiving system including the devices and systems of claim 1, in which after the delivery service user stores the package he/she wishes to send in the storage,
when the delivery service user locks the door with a mechanical lock such as a variable dial lock or a numeric keypad lock, the mechanical lock's unlocking code is communicated to the delivery person by telephone or e-mail, etc., to unlock the door,
when the delivery service user uses the wireless locking and unlocking means, after registering a package pickup request with the delivery person via the dedicated application in advance, the delivery person that has arrived at the pickup destination transmits a package pickup door unlocking request signal including the delivery person information and current location information, and the dedicated application automatically transmits an unlocking code to the delivery person's communication means, and the dedicated application transmits the unlocking code to the wireless locking and unlocking means via the short-range communication means of the delivery person's communication means to unlock the door.
